(19) United States
(12) Patent Application Publication
(10) Pub. No.: US 2026/0355034 A1
(43) Pub. Date: Nov. 12, 2026

(54) MODULAR PAPR SYSTEMS AND MODULES, ACCESSORIES AND METHODS THEREFOR

(71) Applicant: WIN-SHIELD MEDICAL DEVICES INC., Winnipeg (CA)

(72) Inventors: Robert Ranson, Winnipeg (CA); Xudong Jiang, Burnaby (CA); Lionel Dueck, Calgary (CA); Matthew Olson, Winnipeg (CA)

(21) Appl. No.: 19/121,703

(22) PCT Filed: Oct. 25, 2023
(86) PCT No.: PCT/CA2023/051423

§ 371 Date: Apr. 16, 2025

(30) Foreign Application Priority Data
Oct. 25, 2022 (CA) 3179734

(51) Int. Cl. A61G 10/04; A61G 10/00; A62B 18/00; A62B 18/02; A62B 23/02; A62B 25/00

(52) U.S. Cl. CPC A61G 10/04; A61G 10/005; A62B 18/006; A62B 18/02; A62B 23/02; A61G 2200/32; A62B 25/00

(57) ABSTRACT

A modular PAPR system features a blower module, and a removable battery module matable for on-board DC powering thereof when coupled thereto. The blower module is also connectable to an AC mains power outlet when the battery module is removed. The blower and battery modules are also electrically connectable via a DC power cable. Auxiliary ports on the battery module enable connection of other modules and accessories, including an in-line air cooler operable to cool the air from the blower module. A dual filter module enables coupling of one or two cannister or cartridge filters to an intake of the blower module. The blower module can feed a head or full body tent erected over a bed to provided filtered/cooled air to a bed occupant. A rim assembly is couplable to a head-borne shield to secure a flexible sheet thereto and thereby form a more comprehensive head covering.

### CROSS-REFERENCE TO RELATED APPLICATIONS

This application claims priority of Canadian Patent Application No. 3,179,734, filed Oct. 25, 2023, the entirety of which is incorporated herein by reference.

### FIELD OF THE INVENTION

The present invention relates generally to respirators, and more particular powered air purifying respirators (PAPRs).

### BACKGROUND

The COVID-19 pandemic has demonstrated the vast importance of ensuring availability of adequate personal protective equipment (PPE) to essential workers, and particularly to medical personnel who run perhaps the greatest risk of exposure, and whose collective wellbeing is critical in order to sustain sufficient healthcare coverage for the broader population. As a result, more than ever, there is a demand to novel solutions in the field of PPE that can at least partially mitigate recently faced challenges that arose during a combination of high-volume demand, inventory shortages, and supply chain disruption. Though original motivation for Applicant's novel contributions to this field of endeavor originally arose in this context of medical PPE for health care workers, the same inventive principles derived for such purpose can also be put to use any variety of other environments or industries where respirators are useful or required, including industrial applications, agricultural applications, pharmaceuticals, petro-chemical and other chemical applications, mining, metal fabrication, oil and gas, military, law enforcement, and firefighting.

### SUMMARY OF THE INVENTION

According to a first aspect of the invention, there is provided a modular powered air purifying respirator (PAPR) system convertible between differently powered modes of operation, said modular PAPR system comprising:

a blower module having an air inlet through which air is admissible into the blower module and an air outlet through which air is exhaustible from said blower module, said blower module housing one or more electrical components, including at least a motorized blower operable to draw and exhaust air into and from the blower module via said air inlet and said air outlet, respectively;
a removable module, and configured for selective mechanical and electrical coupling to the blower module in a mated position therewith establishing electrical connection a control circuit of the motorized blower to enable powered operation thereof from said removable module; and
a cable connector possessed by the blower module, and also connected to the control circuit of the motorized blower to allow selective powering thereof, independently of the removable module, from mains power via selective connection of a power cable to said cable connector.

Preferably, said removable module is a battery module hosting one or more batteries by which, in coupled presence of the removable module, the control circuit is powered.

According to a second aspect of the invention, there is provided an air delivery system for a bed occupant lain atop a bed, said system comprising:
a blower module having an air inlet through which air is admissible into the blower module and an air outlet through which air is exhaustible from said module, said blower module housing one or more electrical components, including at least a motorized blower operable to draw and exhaust air into and from the blower module via said air inlet and said air outlet, respectively;
a tent erected or erectable over at least part of the bed to at least partially enclose at least a headspace around a head of the bed occupant when lain atop said bed;
an air conduit connected or connectable to the air outlet of the blower module and routed or routable therefrom to a working position feeding air from the blower module into the headspace to supply breathable air thereto.

According to a third aspect of the invention, there is provided a modular powered air purifying respirator (PAPR) system comprising:
a blower module having a blower module inlet through which air is admissible into the blower module and a blower module outlet through which air is exhaustible from said module, said blower module housing one or more electrical components, including at least a motorized blower operable to draw and exhaust air into and from the blower module via said air inlet and said air outlet, respectively;
a dual filter adapter module configured for selective coupling with the blower module at the air inlet thereof to occupy a working position adjacent thereto, said dual filter adapter module having two adapter module inlets and a singular adapter module outlet, of which the singular adapter module outlet mates with the blower module inlet in the working position of the dual filter adapter module, and the two adapter module inlets are configured to matably receive respective air filters that, with the dual filter adapter and the air filters installed and the motorized blower running, are operable to filter ambient air drawn into the dual filter adapter through said adapter module inlets and onward into the blower module through the mated adapter module outlet and blower module inlet.

According to a fourth aspect of the invention, there is provided a modular powered air purifying respirator (PAPR) system comprising:
a blower module having a blower module inlet through which air is admissible into the blower module and a blower module outlet through which air is exhaustible from said module, said blower module housing one or more electrical components, including at least a motorized blower operable to draw and exhaust air into and from the blower module via said air inlet and said air outlet, respectively; and
an air cooler module coupled or couplable to the blower module in a state operable to reduce a temperature at which said air is finally outputted from said PAPR system.

In some, but not necessarily all, embodiments, the air cooling module is coupled or couplable to the blower module outlet in downstream relation thereto to provide downstream cooling of outputted air therefrom when coupled thereto.

According to a fifth aspect of the invention, there is provided an air cooler for cooling of output air from a blown air source, said air cooler comprising an air channel having an inlet end through which blown output air from the blown air source is receivable by said air channel, and an opposing outlet end from which said blown output air from the blown air source is exhaustible from said air channel for onward flow to a destination space, and at least one cooling unit disposed in fluidly communicating relationship to the air channel to impart a cooling effect on the blown output air passing therethrough.

According to a sixth aspect of the invention, there is provided a method of cooling blown output air from a blower module of a powered air purifying respirator (PAPR), said method comprising installing an air cooler inline of the blower module and upstream of a destination space to which said blown output air from blower module is conveyed for inhalation. In some, but not necessarily all, embodiments, said air cooler may be installed downstream of the blower module.

According to a seventh aspect of the invention, there is provided an apparatus for converting a head-borne shield into a more comprehensive head covering for a user's head, said apparatus comprising:
a rim assembly comprising:
   a first rim piece for overlying a first peripheral margin area of the head-borne shield at a first side thereof; and
   a second rim piece for overlying a second peripheral margin area of the head-borne shield at an opposing second side thereof, said first and second rims being configured for mated coupling to one another to clamp the first and second peripheral margin areas of the head-borne shield therebetween, thereby rendering said head-borne shield a rimmed shield; and
flexible sheeting that, at a peripheral margin thereof, is secured or securable to the rim assembly, and that also delimits a head opening through which the user's head is admissible to a headspace bound between the flexible sheeting and the rimmed shield.

According to an eighth aspect of the invention, there is provided a method of converting a head-borne shield into a more comprehensive head covering for a user's head, said method comprising assembling together a first rim piece and a second rim piece in a manner sandwiching a peripheral margin area of the head-borne shield therebetween, thereby converting said head-borne shield into a rimmed shield, and, with flexible sheeting secured to the assembled first and second rims at a peripheral margin of said flexible sheeting, delimiting a headspace between the flexible sheeting and the rimmed face shield, into which the user's head is admissible through an opening in said flexible sheeting, whereby the head-borne shield, the assembled rims and the flexible sheeting collectively form said more comprehensive head covering.

According to a ninth aspect of the invention, there is provided a blower module for a powered air purifying respirator, said blower module comprising a main housing, a blower housing movably coupled to said main housing, and a motorized blower housed, at least in part, by said blower housing, and which blower housing comprises both an inlet through which air is drawn by operation of said motorized blower, and an outlet through which said air is exhausted by operation of said motorized blower, wherein, through relative movement of the blower housing relative the main housing, said outlet movable relative to said housing into a plurality of differently aimed positions exhausting said air in different directions from blower module. According to a tenth aspect of the invention, there is provided a modular powered air purifying respirator (PAPR) system comprising:
a blower module having an air inlet through which air is admissible into the blower module and an air outlet through which air is exhaustible from said blower module, said blower module housing one or more electrical components, including at least a motorized blower operable to draw and exhaust air into and from the blower module via said air inlet and said air outlet, respectively; and
a removable module configured for selective mechanical and electrical coupling to the blower module in a mated position therewith establishing electrical connection to a control circuit of the motorized blower to enabled powered operation thereof from said removable module;
wherein the mated position of the removable module is one in which said removable module forms an in-line extension of a housing of said blower module.

According to an eleventh aspect of the invention, there is provided a blower module for a powered air purifying respirator, said blower module comprising a blower housing, a motorized blower housed, at least in part, by said blower housing, an inlet through which air is drawn into said blower housing by operation of said motorized blower, and an outlet through which said air is exhausted from said blower housing by operation of said motorized blower, wherein said inlet comprises internally threaded coupling wall spanning around an inlet opening of said inlet for selective coupling of a threaded neck of a threaded filter or threaded filter adapter to said internally threaded coupling wall to thereby selectively install said threaded filter or threaded filter adapter in operable relationship to said inlet opening for the purpose of filtering air admitted therethrough, and said inlet further comprises a pad support residing externally of the internally threaded coupling wall for selectively seated receipt on said pad support of a pad filter, for use thereof as an alternative filtration option to said threaded filter or threaded filter adapter, whereby said inlet of the blower module is compatible with multiple filtration options.

According to a twelfth aspect of the invention, there is provided a modular powered air purifying respirator (PAPR) system comprising:
a blower module having an air inlet through which air is admissible into the blower module and an air outlet through which air is exhaustible from said blower module, said blower module housing one or more electrical components, including at least a motorized blower operable to draw and exhaust air into and from the blower module via said air inlet and said air outlet, respectively; and
a removable module configured for selective mechanical and electrical coupling to the blower module in a mated position therewith establishing electrical connection to a control circuit of the motorized blower to enabled powered operation thereof from said removable module;
one or more auxiliary connectors on one of said modules by which one or more other modules or accessories are also connectable for powering of said other modules or accessories from said one of the modules.

### BRIEF DESCRIPTION OF THE DRAWINGS

Preferred embodiments of the invention will now be described in conjunction with the accompanying drawings in which:

FIG. 1 is a perspective view of blower, battery and pad filter modules of a modular powered air purifying respirator (PAPR) system of the present invention, of which the blower and battery modules are shown in an assembled state, and the pad filter model is shown in an exploded state decoupled from the blower module.

FIG. 2 is a perspective view of the same blower, battery and pad filter modules of FIG. 1, but with the pad filter module installed on the blower module.

FIG. 3 is a perspective view of the same assembled blower and battery module of FIG. 1, with the pad filter module omitted, and replaced with a substitutable dual filter adapter module.

FIG. 3A is a cross-sectional view of the blower, battery and dual filter adapter modules of FIG. 3, as sectioned in a longitudinal midplane denoted by line A-A of FIG. 3.

FIG. 4 is an isolated bottom perspective view of the same dual filter adapter module of FIG. 3, showing an outlet thereof at which the dual filter adapter is couplable to an inlet of the blower module.

FIG. 5 is a perspective view of the same blower, battery and dual filter adapter modules of FIG. 3, but with the dual filter adapter module installed on the blower module with a pair of canister filters.

FIG. 6 is a perspective view of the same assembled blower and battery modules of the preceding figures, with an air cooler module installed at an outlet of the blower module to cool the blown output air emitted therefrom.

FIG. 7 is an exploded perspective of the air cooler module of FIG. 6.

FIG. 8 is a perspective view of the same blower and battery modules of the preceding figures, with the removable battery module decoupled from the blower module.

FIG. 9 is another perspective view of the same blower and battery module as FIG. 8, showing an electrical connector socket on the blower module that is revealed by removal of the battery module.

FIG. 10 is another perspective view of the same blower module as FIGS. 8 and 9, together with an AC/DC power supply module connectable to the socket of the blower module for powering thereof via AC mains power when the battery module is removed.

FIG. 11 is a perspective view illustrating use of the blower module and AC/DC power supply module of FIG. 10 with an accompanying air hose and head tent to feed air to a headspace of a bed occupant.

FIG. 12 is a perspective view illustrating use of the blower module and AC/DC power supply module of FIG. 10 with an accompanying air hose and full body tent to feed air to a full body space of a bed occupant.

FIG. 13 is another perspective view of the same decoupled blower and battery modules as FIG. 8, and illustrating use of a power cord to establish electrical connection therebetween in said decoupled state to enable wearing of the two modules at different locations on a user's body.

FIG. 14 is a top plan view of the same blower module as the preceding figures, with a blower housing thereof swiveled to reposition its outlet duct from the straight-aimed position of the preceding figures to an obliquely aimed position.

FIG. 15 is another top plan view of the blower module of FIG. 14, but with the blower housing swiveled even further to reposition its outlet duct to a laterally-aimed position.

FIG. 16 is an exploded perspective view of a novel PAPR headgear assembly of the present invention, wherein a cooperating pair of front and rear rims are snap-fitted together on an outer perimeter of a face shield to attach a flexible sheet thereto to achieve a more enclosed and comprehensive head covering.

FIG. 17 is an elevational rear view of a PAPR headgear assembled from the FIG. 16 components, showing the flexible sheet spanning a rear opening of the face shield, while having an opening to accommodate insertion of the user's head into the headspace bound between the sheet and the face shield.

FIG. 18 is a cross-sectional view of the assembled rims of the headgear of FIG. 17, as viewed along line A-A thereof.

FIG. 19 is a perspective view of an alternative embodiment of the blower module which, aside from a smaller longitudinal footprint, has a modified inlet capable of direct mounting of a singular cannister filter thereon without the adapter module of FIGS. 3 to 5.

FIG. 20 is a perspective view of the blower module of FIG. 19 with a cannister filter installed directly thereon.

### DETAILED DESCRIPTION

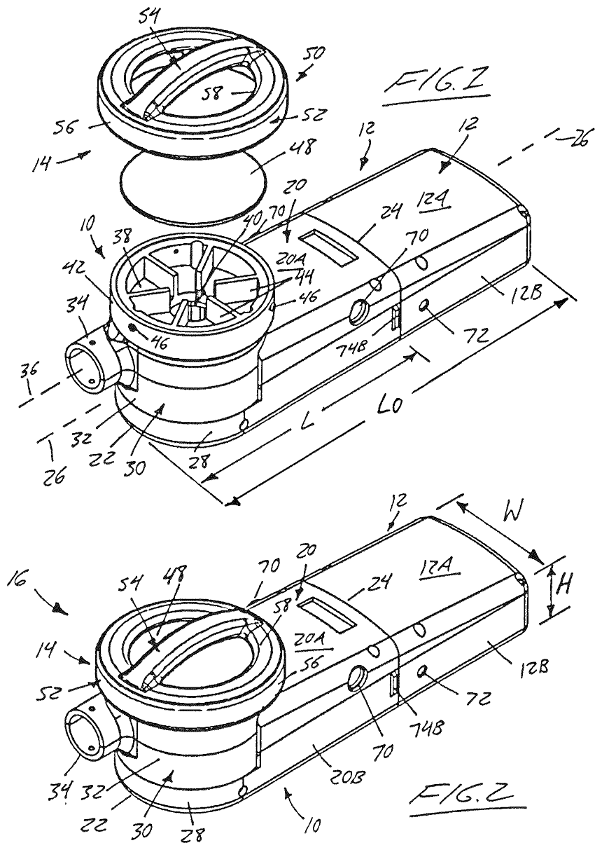

FIG. 1 shows a blower module 10 and a removably attached battery module 12 that are assembled together, but shown in exploded relation to an accompanying pad-filter module 14 installable on the blower module, whereby the assembly of these three modules form a fully functional air supply assembly 16 of a powered air purifying respirator (PAPR), a remainder of which is typically embodied by the combination of a flexible air hose and a wearable headgear for enclosing a facial area or entire head of a user of the PAPR, whereby the air supply assembly 16 is operable to convey a stream of breathable filtered air to the headgear via the flexible air hose for inhalation by the user.

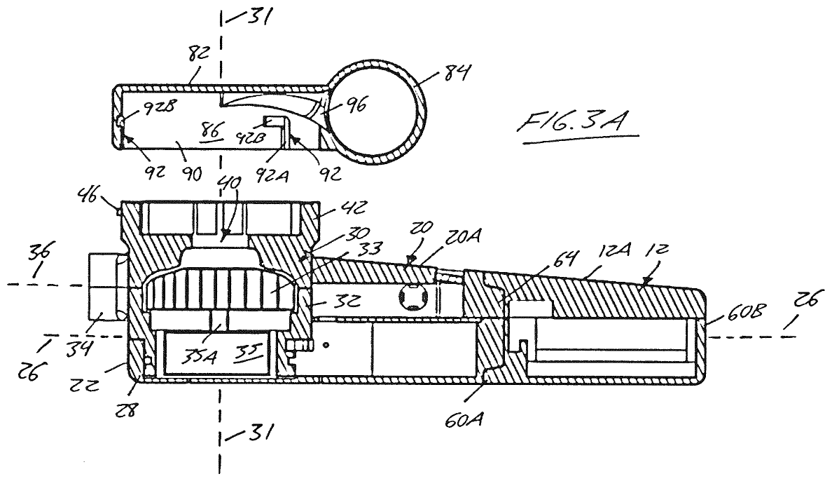

The blower module 10 comprises an elongated main housing 20 having a blower end 22 and a battery end 24, which are of opposing relation to one another in a longitudinal direction that is denoted by longitudinal axis 26, and in which an elongated length dimension L of the main housing 20 is measured. A lesser width dimension W of the main housing 20 is measured perpendicularly transverse (orthogonally) of length dimension L, and an even lesser height dimension H of the main housing 20 is measured orthogonally of both the length and width dimensions. A blower segment 28 of the main housing refers to a portion thereof spanning a partial fraction (e.g. less than half) of the main housing's overall length L from the blower end 22 thereof, and this blower segment 28 is off lesser height than a remainder of the main housing that spans from the blower segment 28 to the opposing battery end 24 of the main housing. This reduced-height blower segment 28 receives a bottom end of a generally cylindrical blower housing 30 of the blower module 10. An outer periphery of the blower segment 28 has an arcuate profile, imparting a rounded shape to the blower end 22 of the main housing 20, which conforms to an overlying semi-cylindrical half of a cylindrically round outer wall 32 of the blower housing 30. The blower housing 30 also features a short outlet duct 34 that protrudes a short distance outward from the blower housing's cylindrical outer wall 32 in a tangentially oriented relation thereto. A blower wheel 33 (schematically shown in FIG. 3A) rotatably supported within blower housing is surrounded by, and resides concentrically of, the cylindrical outer wall 32, and is accompanied by a blower motor 35 whose driveshaft 35A is axially coupled to a center of the blower wheel to drive rotation thereof.

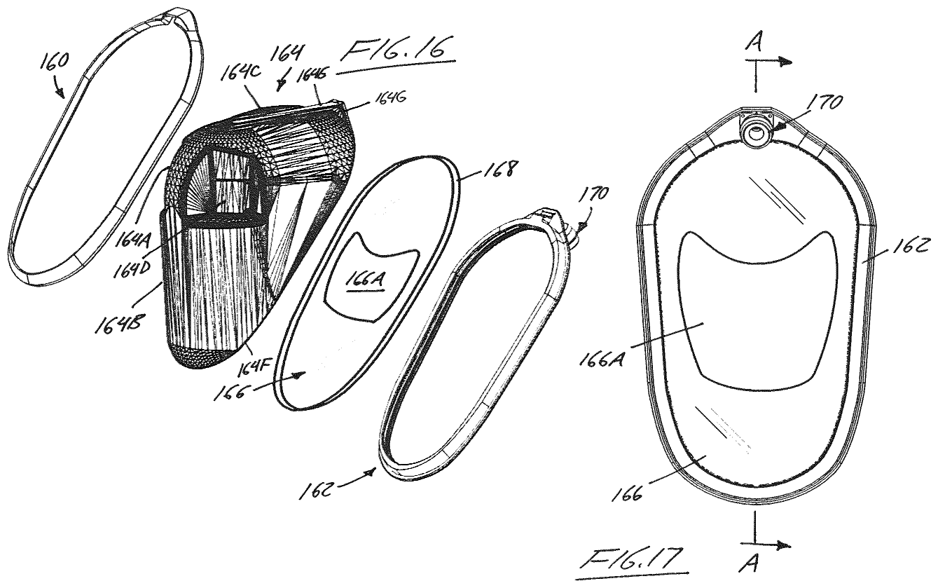

In the illustrated embodiment, the blower housing 30, instead of being rigidly affixed to the main housing 20, is rotatably coupled thereto to allow selective swivelling of the blower housing 30 around a central blower axis 31 thereof (FIG. 3A) on which the cylindrical wall 32, blower wheel 33 and motor driveshaft 35A are all centered. This central blower axis 31 lies orthogonally of the longitudinal axis 26, whereby the length dimension L and the longitudinal directionality thereof lie radially of the central blower axis 32. Through such swivelling motion about the central blower axis 31, the blower housing 30 can be rotatably adjusted among multiple positions, each corresponding to a different unique orientation of the tangential outlet duct 34 relative to the longitudinal axis 26 of the main housing 20. Using a relative directionality of the tangential outlet duct to name different acquirable positions of the blower housing, FIGS. 1-3, 5-6 and 8-12 show the blower housing 30 in a straight-aimed position aiming the tangential outlet duct parallel to the longitudinal axis 26, as illustrated by the parallel relationship of outlet duct axis 36 to longitudinal axis 26 in FIG. 1. FIG. 15 instead shows the blower housing 30 in a laterally-aimed position aiming the tangential outlet duct perpendicular to the longitudinal axis 26, while FIG. 14 shows the blower housing in an obliquely-aimed position aiming the tangential outlet duct obliquely of the longitudinal axis 26, for example at 45-degrees thereto. In use of the blower module in a fully assembled PAPR, an air hose is coupled, directly or indirectly, to the outlet duct 34 of the blower housing 30 so that air blown from the outlet duct 34 via operation of the motorized blower wheel 33 inside the blower housing 30 blows such air onwardly through the connected air hose to the user-worn headgear.

Accordingly, the aimable character of the outlet duct 34 enables the user to optimize the orientation thereof to best suit a particularly optimal routing path for the air hose in any given application, which may vary depending on the relative locations of the blower module and the headgear, or relative locations of the blower module and any other equipment to which the blower module is instead connected by the air hose, illustrated examples of which are described herein further below. In the example where the blower module is borne by the user and connected to likewise user-borne headgear, the aiming of the outlet duct 34 of the blower housing 30 can be used to select an optimal orientation of the outlet duct depending on the blower housing's whereabouts on the user's body, for example depending on whether the blower module is worn on a waist belt, shoulder harness, backpack, etc.

In the present description, the terms “top” and “bottom” are used in relation to the illustrated orientation of the blower module 10 in FIGS. 1 and 2, where the length and width dimensions L, W thereof are oriented horizontally, and the height dimension H and the central blower axis 31 are oriented vertically. The bottom end of the blower module 10 is received by the blower segment 28 of the main housing 20, and coupled thereto in a rotatable manner enabling the aforementioned swivelling of the blower housing 30 about its central axis. The bottom end of the blower module 10 is an open bottom, such that the blower motor 35 can be mounted to the blower segment 28 of the main housing 20 in a fixed position thereon. The blower wheel 33 attached to the blower motor's driveshaft 35A is thus supported within the blower housing 30, but in detached relationship from the surrounding cylindrical wall 32 thereof. As revealed by the removed character of the pad filter module 14 in FIG. 1, a top end of the cylindrical wall 32 of the blower housing 30 is partially capped off by an annular cover wall 38 thereof that surrounds a central inlet opening 40 of the blower housing, which axially and centrally overlies the blower wheel 33 inside the blower housing 30. Accordingly, motor-driven rotation of the blower wheel 33 draws air into the blower housing 30 through this inlet opening 40 at the top of the cylindrical housing wall 32, and then exhausts such air through the tangential outlet duct 34.

A top end of the blower housing 30, above the capped top end of the cylindrical wall 30, is characterized by an also cylindrical perimeter wall 42 of upstanding relation to the annular cover wall 38, and surrounding and concentric relation to the inlet opening 40. The perimeter wall 42 is accompanied by a set of internal ribs 44 that radiate inwardly from an inner surface of the perimeter wall 42 at spaced intervals therearound. The central inlet opening 40 must be left at least partially unobstructed to allow airflow therethrough, and for such reason, the ribs 42 may terminate short of the central inlet opening 40 so as to be of entirely non-obstructive relation thereto, as illustrated, thus leaving open a full area of the inlet opening 40. A plurality of coupling studs 46 protrude externally from the outer surface of the perimeter wall 42 at discretely spaced positions therearound, and in the illustrated example are embodied by a set of three such coupling studs 46 disposed at equal 120-degree intervals around the perimeter wall 42. The stud-equipped perimeter wall 42 provides a mounting interface by which any one of a number of different filter modules can be selectively and removably coupled to the blower module for the purpose of operably supporting a filtration means in operable relation to the inlet opening 40 in order to filter the ambient air that is drawn therethrough by motorized operation of the blower wheel 33.

FIGS. 1 and 2 show the blower module in combination with a pad filter module 14 composed of a replaceable filter pad 48 and a reusable one-piece pad holder 50 that comprises an annular holding collar 52 with a cross-bar 54 spanning internally thereacross. The holding collar 50 has a cylindrical outer wall 56, and an in-turned flange 58 jutting inwardly from the cylindrical wall 56 at the top end thereof. The inner diameter of the cylindrical wall 56 slightly exceeds the outer diameter of the perimeter wall 42 around the inlet opening 40 of the blower housing 30 to enable external fitting of the holding collar's cylindrical wall 56 over the blower housing's perimeter wall 42. The inner diameter of the holding collar's in-turned flange 58 is less than the outer diameter of the blower housing's perimeter wall 42, so that when the holding collar 52 is fitted over the perimeter wall 42, the in-turned flange 58 juts inwardly over the annular top edge of the perimeter wall 42. The interior surface of the holding collar's cylindrical wall 56 features a set of three L-shaped slots at spaced intervals around the cylindrical wall 56 that match the interval spacing of the three studs 46 on the perimeter wall 42. These slots are of the same type described further down with reference to in the different substitutable filter module of FIG. 4, where such slots 92 are visible, and labeled. In the case of the pad filter holder 50, an axial leg of each L-shaped slot has an outer end that intersects the non-flanged annular bottom end of the cylindrical wall 56, i.e. the end thereof opposite the in-turned flange 58. A circumferential leg of each slot extends in the circumferential direction of the cylindrical wall 56 from an inner end of the axial slot furthest from the non-flanged bottom end of the cylindrical wall 56. The studs 44 and slots 92 cooperate to enable a bayonet-style slide-and-turn coupling and securement action between the holding collar 50 and the perimeter wall 42.

This coupling is performed with the filter pad 48 disposed between the in-turned flange 58 of the pad holder 50 and the annular top edge of the blower housing's perimeter wall 42, such that the filter pad 48 is securely clamped therebetween in overlying relationship to the inlet opening. As shown in the drawings, the annular top edge of the blower housing perimeter wall 42 may have a stepped, rather than purely flat, profile, such that the annular top edge is characterized by a slightly raised outer lip that surrounds an unraised inner area of the top edge. In such instance, the filter pad 48 sits atop this unraised inner area, and is therefore surrounded by the raised outer lip. The cross-bar 54 of the pad holder 50 partially shields the otherwise exposed filter pad 48, and also serves as a user-graspable handle for performing the slide-and-turn bayonet-style coupling of the pad holder 50 to the blower housing's perimeter wall 42. In place of the cross-bar 54, the pad holder 50 may instead feature an integral mesh or web structure spanning the otherwise open center area of the in-turned flange 58 of the pad holder 50.

The internal ribs 44 radiating inwardly from the blower housing's perimeter wall 42 prevent the filter pad 48 from being sucked into the blower housing through the inlet opening 40 thereof. This pad holder 50 and its slide-and-turn bayonet-like coupling to a studded perimeter wall around an inlet opening the blower housing, and a plurality of different types of filter holders interchangeable therewith to support other types of filters in operable relation to the inlet opening of the blower module 10 are fully described in Applicant's co-pending PCT Application No. PCT/CA2022/51408, filed Sep. 22, 2022, the entirety of which is incorporated herein by reference.

In the illustrated example, the perimeter wall 42 around the inlet opening 40 is of slightly greater diameter than the cylindrical wall 32 of the blower housing 30 to accommodate filters whose diameter or outer profile are of a size exceeding the diameter of the blower housing's cylindrical wall 32, though this need not necessarily be the case. For example, in other scenarios of different relative sizing between the blower housing and intended filtration means, the perimeter wall 42 may be an equal-diameter extension of the underlying cylindrical wall 32 that surrounds the blower wheel 33. Depending on the type of filtration means and relative rigidity thereof, the ribs 44 for preventing sucked intrusion of the filtrations means through the inlet opening 40 may optionally be omitted. In the illustrated embodiment, the inlet opening 40 and the surrounding perimeter wall 42 collectively denote the air inlet of the blower module, where ambient air is drawn into the blower module via any filtration means supported at this air inlet in overlying relation to the inlet opening 40 thereof.

The battery module 12 is removably attachable to the main housing 20 of the blower module 10 at the battery end 24 thereof, and when so installed, forms an inline longitudinal extension of the blower module's main housing 20, that supplements the length L thereof in the direction of longitudinal axis 26. In this installed position of the battery module 12, its top 12A, bottom (unlabelled) and two side walls 12B reside respectively flush with the top 20A, bottom (unlabelled) and two side walls 20B of the main housing 20 of the blower module 10, to form smoothly continuous extensions thereof, whereby the assembled modules can be comfortably grasped and held in one hand, with indiscriminate hand placement anywhere along the combined lengths of the assembled blower and battery modules, without change to the general feel and grip thereof. The battery module 12 is composed of a respective housing 60 (referred to herein as a battery housing, to differentiate same from the main and blower housings of the blower module, already described above), which defines the aforementioned walls of the battery module, and inside of which one or more rechargeable, batteries are housed. A proximal end 60A of the battery housing refers to an end thereof that mates with the battery end 24 of the blower module's main housing 10, and a distal end 60B of the battery housing resides oppositely of the proximal end 60A in the longitudinal direction denoted by axis 26, and thus resides distally of the blower module 10 when the battery module 12 is coupled thereto.

The battery module and the main housing of the blower module, in cross-sectional planes lying orthogonally of the longitudinal axis 26, are of matching external shape profile, at least at the battery end 22 of the blower module 10 and at the proximal end 60A of the battery module, and the coupled battery module 12 extends the main housing 20 of the blower modular 10 only longitudinally (i.e. lengthwise), without corresponding increase to the width and height dimensions W, H of the assembled modular PAPR. A combined overall length Lo of the assembled blower and battery modules 10, 12 in the longitudinal direction denotes a greatest of the overall dimensions of the assembled modular PAPR, which may likewise be true in other embodiments, even where the length L of the blower module's main housing 20 is not necessarily the greatest of the length, width and height dimensions thereof. The modular design is also one in which the installation of a filter or filter module builds on the height measurement (corresponding to the axial direction of the blower) without any increase to the length measurement of the PAPR in the longitudinal direction denoting its greatest assembled dimension.

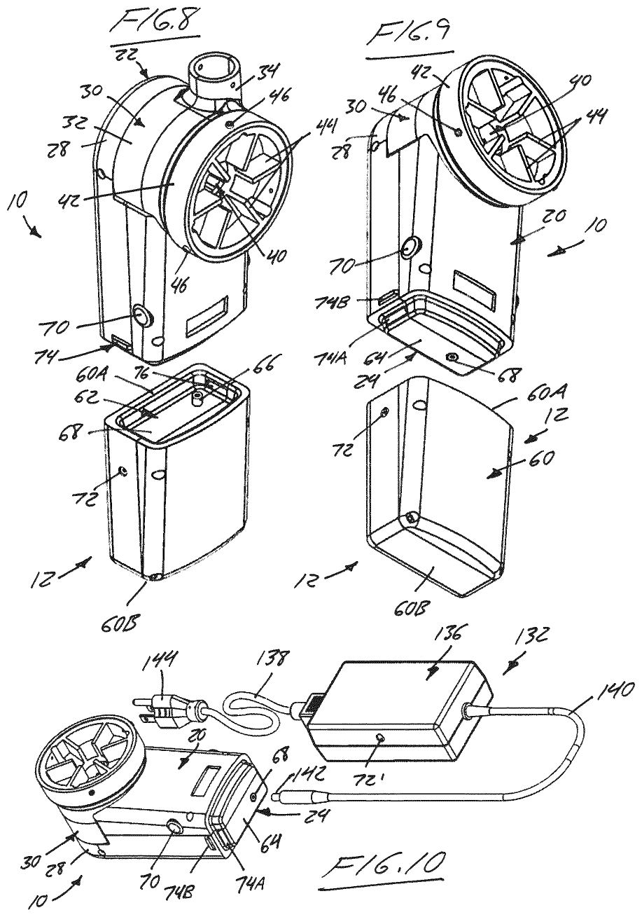

Turning to FIGS. 8 and 9, where the blower and battery modules 10, 12 are shown in decoupled and exploded relation to one another, the proximal end 60A of the battery housing 60 is characterized by a recessed female cavity 62 of matable size and shape to a corresponding male protrusion 64 on the main housing 20 of the blower module 10 at the battery end 24 thereof. A first electrical connector 66, embodied by a barrel plug in the illustrated but non-limiting example, resides within the recessed female cavity 62 of the battery housing 60 in protruding relationship to the surrounding floor 66 of the cavity 62. A second electrical connector 68, embodied by a barrel socket in the illustrated example, of matable relation to the first electrical connector 66 is provided on the protrusion 64 of the blower module's main housing 20 at a matching position that self-aligns with the first electrical connector 66 upon physical mating of the blower and battery modules to one another. Physical mating of the battery module 12 to the blower module 10, and the automatic connection of the two electrical connectors 66, 68 that occurs during such mating, thus electrically connects the one or more batteries of the battery module 12 to control circuitry (not shown) of the blower module 10 that is housed within the main housing 20 thereof. This control circuitry is connected to the blower motor 35 to control operation thereof, preferably via one or more user-actuable control inputs 70, for example embodied by one or more push-button switches at one or both side walls of the blower module's main housing 20.

While the matable shapes of the blower module's battery end 22 and the battery module's proximal end 60A are characterized as male and female, respectively, in the illustrated embodiment, this male/female designation may be reversed, just as the plug/socket designation of the respective first and second electrical connectors 66, 68 may likewise be reversed. In addition to battery module's electrical connector 66 at the proximal end 60A of the battery housing 60, the battery module 12 of the illustrated example includes at least one auxiliary electrical connector 72, one of which can be seen on one of the battery housing's side walls 12B, of which there may be another such auxiliary electrical connector at the opposing side wall of the battery housing 60. Additional or alternative locations for such one or more auxiliary electrical connectors may include at the distal end 60B, top or bottom of the battery housing, at any of which such additional electrical connector(s) would be accessible to the user, even when the battery module 12 is installed on the blower module, unlike connectors 68 and 68 that are inaccessible in such state. Via the one or more auxiliary electrical connectors 72, other equipment or accessories can be electrically connected to the one or more batteries of the battery module 12 for powering of such other equipment or accessories thereby, even when the battery module 12 is installed on the blower module 10 for the purpose of powering same.

The modular design of the PAPR air supply assembly 16 may include multiple battery modules 12 of varying size, weight and/or battery capacity, for example including smaller and lighter battery modules of lesser battery capacity for use in instances where the required run-time of a PAPR is lesser than in other instances that demand larger and heavier battery modules for a longer run-time. In instances where the PAPR is borne by the user, the reduced weight and bulkiness of the smaller/lighter battery module for short-run use presents an advantage to the user, being less detrimental to their physical energy and maneuverability. The smaller and lighter battery modules may also be sold at a lesser price point, to the financial benefit of purchasers in need of PAPR equipment in situations where short-run use between suitably long recharging windows is sufficient. Preferably, the larger heavier battery modules are longer than the shorter lighter battery modules, but retain the same profile shape in cross-sectional planes normal to the longitudinal axis 26, and thus again reside purely in-line with the blower module 10, in flush relation to the main housing walls thereof, without increase to the cross-sectional profile of the overall air supply assembly 16, thus maintaining the same comfortable and uniform manual grip shape throughout the length of the assembly, regardless of the actual collective length of the assembled blower and battery module.

Still referring to FIGS. 8 and 9, to hold the blower and battery modules 10, 12 together once mated, the illustrated embodiment employs a pair of snap clips 74 at opposing sides of the main housing 20 of the blower module 10. Each snap clip 74 has a catch tang 74A that protrudes slightly from a respective side of the male protrusion 64 at the main housing's battery end 22 through a small window in this respective side of the protrusion 64. Inside the main housing 20, the snap clip runs from this catch tang 74A to a user-depressible head 74B of the snap clip 74, which similarly protrudes through a small window in a respective outer side wall 20B of the main housing 20, at a location spaced a short longitudinal distance away from the protrusion 64 and toward the blower segment 28. Two opposing side walls of the female cavity 62 of the battery module each feature a respective catch pocket 76 therein, into which the catch tang 74A of a respective snap clip 74 resiliently snaps when the two modules 10, 12 are mated together, whereby the tang is caught under an overhanging lip of the pocket 76. When detachment of the battery module 12 is desired, the user depresses the heads 74A of the two snap clips 74 inwardly toward one another at the opposing side walls 20B of the blower module's main housing 20, which displaced the two snap clips 74 inwardly toward one another, thus withdrawing their respective catch tangs 74A into the male protrusion 64 and out of the catch pockets 76 of the battery module 12, and thereby decoupling the battery module 12 from the blower module 10. Suitable biasing springs (not shown), normally bias the clips outwardly away from one another, whereby the snap clip coupling of the modules is self effecting, and retained in absence of user depression of the release heads 74B of the snap clips.

Having described the interconnectivity of the blower and battery modules 10, 12, attention is now turned back to installation of interchangeable filter modules onto the blower module. As a substitutable alternative to the pad filter module 14 of FIGS. 1 and 2, and likewise as a substitutable alternative to the other filter modules previously disclosed in Applicant's aforementioned co-pending PCT application, FIGS. 3 to 5 illustrate a novel dual-filter adapter module 80 of the present invention. The adapter module 80 is a single-piece module composed of a plenum body 82 and an inlet tube 84. The plenum body is sized and shaped for mated engagement with the blower module 10 at the inlet perimeter wall 42, and to slightly overhang the perimeter wall 42 to one side thereof in cantilevered fashion therefrom to carry the inlet tube 84 in spaced relation from, and tangentially oriented relation to, the inlet perimeter wall 42 off to said one side thereof.

The plenum body 82 is hollow and thus has an internal plenum cavity 86, which can be seen in the inverted bottom view of the adapter module 80 in FIG. 4. Here, at an underside of the plenum body that faces the blower module 10 when the adapter module 80 is installed thereon, the plenum cavity 86 has an open bottom 88 of circular shape for fitted placement of this open bottom 88 of the plenum cavity 86 over the cylindrically round inlet perimeter wall 42 of the blower module 10. Over a partial fraction of the plenum cavity's depth, starting from the open bottom 88 thereof, the plenum cavity is surrounded by a cylindrically round boundary wall 90. L-shaped coupling slots 92 of the same shape and quantity described above for the pad holder 50 are provided in this boundary wall 90 of the plenum cavity 86 at discretely spaced intervals therearound (e.g. 3-slots, at 120-degree intervals) for slide-and-turn bayonet-style engagement of the plenum body 82 with the coupling studs 46 on the inlet perimeter wall 42 of the blower module 10. An axial leg 92A of each L-shaped slot 92 has an open outer end at the bottom 88 of the plenum body 86, and a circumferential leg 92B of each L-shaped slot 92 extends in the circumferential direction of the cylindrical boundary wall 90 from an opposing inner end of the axial slot that resides furthest from the open bottom 88 of the plenum body 86 and nearest a closed and opposing top wall 82B thereof. The studs 46 and slots 92 cooperate to enable a bayonet-style slide-and-turn coupling and securement action between the adapter module 80 and the blower module's inlet perimeter wall 42. The placement of the studs 46 on the inlet perimeter wall 42, and the length of the circumferential legs 92B of the coupling slots 92 of the dual filter adapter module 80 are cooperatively set such that when the dual-filter adapter module 80 is installed on the straight-aimed blower module, the inlet tube 84 of the adapter module 80 lies parallel to the width W of the blower module 10.

The inlet tube 84 is open at two opposing ends 84A, 84B thereof, and is internally threaded, at least at end portions thereof adjacent these two opposing ends 84A, 84B, if not throughout an entire axial length of the tube 84. Each open and internally/female threaded end 84A, 84B of the inlet tube 84 thereby defines a respective air inlet of the adapter 80 through which air can be introduced to the adapter 80, and to which a cannister filter 94 (e.g. a CBRN cannister filter-for chemical, biological, radiological, nuclear applications) with an externally/male threaded neck (e.g. 40 mm NATO thread) can be threadingly coupled to filter such air as it enters the adapter 80 using internal. A side of the inlet tube 84 facing the attached plenum body 82 has an open window 96 therein that fluidly communicates the interior of the hollow inlet tube 84 with the hollow plenum cavity 86 of the plenum body 82. Except for its open bottom 88 and the open window 96, the internal plenum cavity 86 of the plenum body 82 is fully enclosed. As shown, the plenum body may have a U-shaped outer periphery in plan view, being rounded at the end 82A thereof opposite the inlet tube 84 so as to closely conform with the rounded cylindrical shape of the blower housing 30 and the underlying blower segment 28 of the main housing at the blower end 22 of the blower module 10.

The open window 96 of the inlet tube 84 and corresponding semi-cylindrical half of the cylindrical boundary wall 90 of the plenum cavity 86 occupy different respective fractions of the overall elevational depth of the plenum cavity 86. In the installed position of the dual filter adapter module 80, the cylindrical boundary wall 90 of the plenum cavity spans around the inlet perimeter wall 42 of the blower module 10, while the communicating window 96 between the inlet tube 84 and the plenum cavity 86 resides at a greater elevation range, at least part of which resides above the plane of the inlet perimeter wall's top edge. A plenum space thus exists in the elevational range between the plane of the inlet perimeter wall's top end, and the overlying top wall 82B of the plenum body 82. During operation of the blower module with the dual-filter adapter module 80 and cannister filters 94 installed, ambient air is drawn into the adapter 80 through the cannister filters 94 at the two inlets 84A, 84B of the adapter 80 as a result of the blower wheel's motor driven rotation. This incoming airflow, now filtered by the cannister filters 94, is drawn further onward from the inlet tube 84 through the window 96 into the plenum space that is bound within the plenum body 82 above the top edge of the inlet perimeter wall 42 of the blower module 10. From this plenum space, the filtered air is then drawn downwardly through the inlet opening 40 of the air module into the blower housing 30, and then exhausted therefrom via the tangential outlet duct 34. The plenum body 82 doubles as both a physical coupler of the adapter module 80 by which it is removably mountable to the blower module using the L-shaped slots 90 of the plenum cavity's boundary wall 90, and as an airflow outlet of the adapter module 80 from which the filter air enters the blower module 10 via the inlet opening 40.

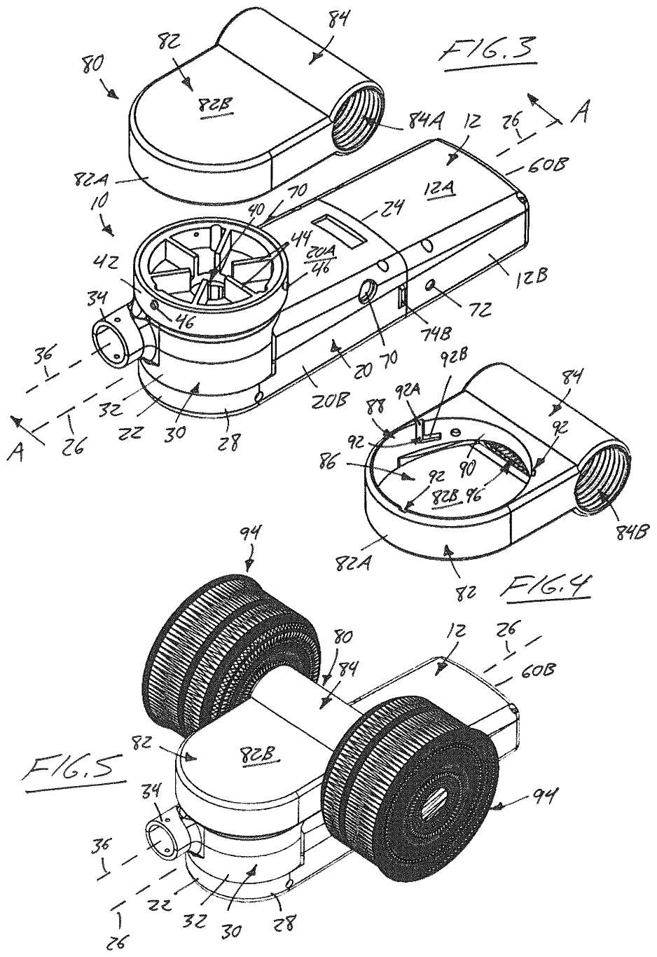

As shown in FIG. 5, the outlet tube 84 of the installed dual filter adapter 80 overlies the blower module's main housing 20 at the side of the blower housing 30 that neighbours the battery end 24 of the main housing, where the main housing 20 is taller than it is at the blower segment 28, yet is shorter than the blower housing 30 from which the inlet tube 84 is cantilevered by the plenum body 82. The two cannister filters 94 coupled to the opposing inlet ends 84A, 84b of the inlet tube 84 respectively reside at opposing sides of the blower module 10, outwardly beyond the side walls 20B of the main housing 20 thereof. While the illustrated example shows two cannister filters 94 installed on the dual filter adapter module 80, to take advantage of its dual-filter capacity, it will be appreciated that, at the user's discretion, one cannister filter 94 may alternatively be installed at one end of the inlet tube 84, and the other end of the inlet tube instead being closed off, for example with a threaded plug, rendering this inlet non-functional, and effectively converting the dual-filter adapter module 80 to a single-filter adapter module. It will also be appreciated that the dual-filter adapter module 80 need not be limited to use with cannister filters 94, and any other filter with a compatibly threaded coupling neck may be directly threaded to the inlet tube 84 of the adapter 80. As a further alternative, a smaller secondary adapter with compatible threading at one of its two coupling interfaces may be used to enable indirect mounting of a non-compatible filter to the dual filter adapter 80 (e.g. an adapter with 40 mm NATO threading at one coupling interface for connection to the adapter 80, and a bayonet style configuration at its other coupling interface for connection of cartridge filters with bayonet connectors). Such NATO to bayonet adapters are commercially available, and thus not further described nor illustrated herein.

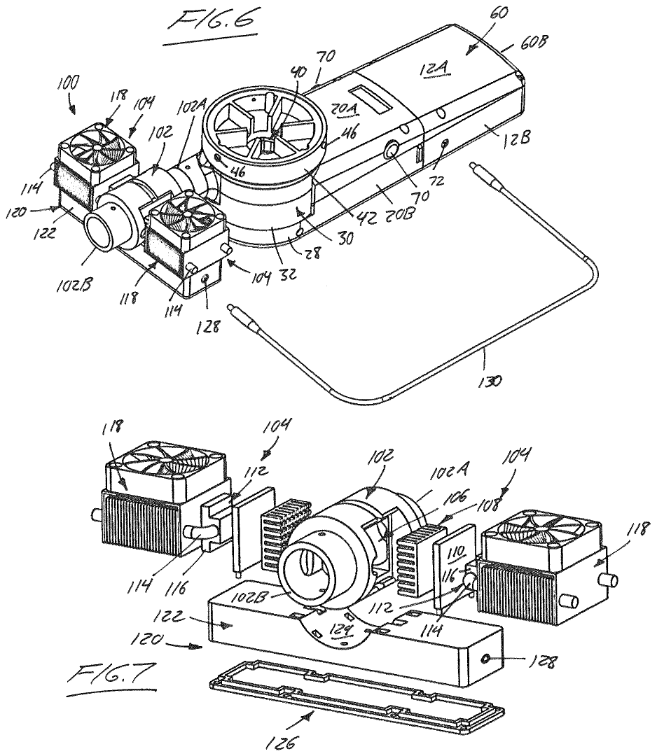

Turning to FIGS. 6 and 7, illustrated therein is an air cooler module 100 selectively connectable to the blower module 10, for example by direct mounting of the air cooler module 100 to the outlet duct 34 of the blower module 10 in the illustrated example, though the air cooler may alternative be connected indirectly to the outlet duct 34 via a length of hose, pipe or tubing. The installed air cooler module 100 thus resides downstream of the blower module 10, for the purpose of cooling the filtered air blown therefrom by the motor driven blower wheel 33, whereby the filtered air routed onward from the air cooler module 100 through a connected air hose to its final destination where it will be inhaled by the PAPR user is of lower temperature than would occur in absence of the air cooler module 100. Being embodied as a separate module from the blower module 10, the air cooler module 100 can be specifically employed only when particularly needed or helpful, for example in hot climates or environments where the cooling of the filtered air is more palatable for inhalation, and can also serve to help cool the user's face, or entire head, depending on the type of equipment to which the cooled air is delivered for final inhalation (e.g. user-born headgear, such as a facemask, face shield, hood; or a head or body tent, as contemplated herein further below).

The air cooler module 100 features a central tubular air channel 102 having opposing inlet and outlet ends 102A, 102B thereof through which air is blown from the outlet duct 34 of the blower module 10 by driven rotation of the motorized blower wheel 33 therein. The inlet end 102A of the tubular air channel 102 may be mechanically coupled in releasable fashion to the tubular outlet duct 34 by any suitable coupling arrangement capable of bearing the weight of the air cooler module 100. A pair of cooling units 104 neighbour the tubular air channel 102 on opposing sides thereof. Each of these two opposing sides of the tubular air channel 102 has a rectangular (e.g. square) opening 106 therein, which accommodates a cold-side heatsink 108 of the respective cooling unit 104. The fins or pins of each cold-side heatsink 108 project into the interior of the tubular air channel 102 and thus into the airflow being blown therethrough, for the purpose of cooling same. As shown, the tubular air channel 102 may have a greater wall thickness at a mid-region thereof between the inlet and outlet ends 102A, 102B than at the end regions adjacent those ends. The greater wall thickness at this mid-region of the air channel 102 better accommodates secure mounting of the cold side heat sinks 108, while retaining a smaller diameter at the ends 102A, 102B of the tubular channel 102 for connection to the blower module outlet duct 34 at the inlet end 102A and fitting of an air hose (not shown) at the outlet end 102B.

The base plate of each cold-side heatsink 108 abuts the cold side of a thermoelectric (Peltier) cooling module 110 of the respective cooling unit 104, whose opposing hot side is mated with suitable heat dissipation componentry. In the illustrated example, this heat dissipation componentry is embodied by a heat pipe cooler 112 composed of a U-shaped heat pipe 114 having a central mounting block 116 abutted against the cold-side of the thermoelectric module 110, and from which the two parallel legs of the U-shaped heat pipe 114 span outwardly away from the tubular air channel 102 through an adjacent fan-cooled heat sink 118. This is just one non-limiting example of a possible cooling setup usable at the hot side of each thermoelectric module 110, and the heat pipe implementation could be replaced with a direct heat sink setup where the base plate of a hot-side heat sink, preferably again fan-cooled, abuts the hot-side of the thermoelectric module 110 directly, in place of the heat pipe 114 and its mounting block 116. In either of these non-limiting examples, a fan-cooled heat sink performs the final heat dispersion to the ambient environment.

The tubular air channel 102 and fan-cooled heat sinks 116 of the two cooling units 104 are mounted atop a shared base 120. This shared base 120 includes a hollow base housing 122 whose topside features an arcuately concave recess 124 for cradled mounting of the tubular air channel 102, and whose open bottom is capped off by a bottom housing cover 126. This hollow base housing 122 contains appropriate electrical circuitry through which the thermoelectric cooling modules 110 and the fans fan-cooled heat sinks 118 are powered and controlled. In the illustrated embodiment, the air cooler module 100 lacks its own on-board power source, and instead relies on electrical connection to the same battery module 12 that powers the blower module 10. For such purpose, another electrical connector 128, embodied by a barrel socket in the illustrated non-limiting example, is provided at an externally accessible location on the base housing 122, for example at an end thereof, whereby a DC power cable 130 is connectable from this electrical connector 128 of the air cooler module 100 to one of the one or more auxiliary electrical connectors 72 on the battery module 12 to enable powering of the air cooler module 100 from the battery module 12.

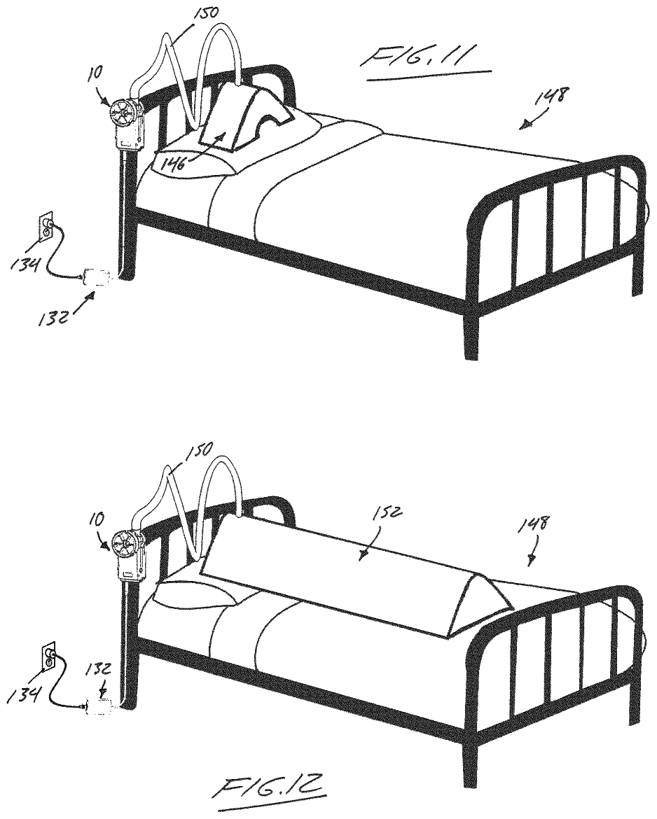

Referring again to FIGS. 8 to 10, the electrical connector 68 on the blower module 10 that is used to electrically interconnect the blower and battery modules 10, 12 is completely obstructed from view and inaccessible when the battery module 12 is installed on the blower module 10, but referring to FIG. 10, is visually revealed and rendered accessible for other purposes when the battery module 12 is removed. FIG. 10 illustrates that the same electrical connector 68 can instead be used to for plugged connection of an AC/DC power supply 132, which in turn can also be plugged into an alternating current (AC) mains power outlet, for example the conventional mains power wall outlet 134 shown in FIGS. 11 and 12, In known fashion, the power supply 132 is operable to convert the AC mains power to direct current (DC) power usable by the blower module circuitry. The type of power supply 132 shown in the drawings is of a dual-cord variety, where the AC/DC power conversion componentry is contained in a housing 136, from one end of which an AC power cord 138 emanates, and from the other end of which a DC power cord 140 emanates. The DC power cord has a DC plug 142 (e.g. barrel plug) for mated connection with the electrical connector 68 (e.g. barrel socket) of the blower module, while the AC power cord has an AC plug 144 for mated connection with the mains power outlet 134. A single-corded “wall wart” power supply may alternatively be used, where the housing 136 instead embodies the AC plug directly thereon, thus omitting the AC power cord 138. The blower module 10 can thus be powered from an AC mains power source for any variety of applications where the mobility afforded by the battery module 12 is not required. The housing 136 of the power supply includes at least one auxiliary electrical connector 72′ (e.g. barrel socket), just like that of the battery module 12, to enable electrical connection of the air cooler module 100 or other DC-powered module/accessory to the power supply 132 to likewise allow running of such module/accessory in the absence of the battery module 12.

FIG. 11 shows one example of an application where the blower module 10 and power supply 132 may be used together for mains powered operation of the blower module at a static location, as opposed to the conventional body-worn context of a PAPR where the blower and other PAPR components are worn by a mobile user who is free to walk or otherwise roam. The FIG. 11 scenario is instead intended to supply a bed occupant, for example, but not limited to, a hospital or care-home patient, with a filtered supply of breathable air, thus protecting the bed occupant from potential airborne pathogens, such as COVID-19. For such purpose, a head tent 146 is erected at the head region of a bed 148 so as to overlie the head of the bed occupant (not shown). The blower module 10 is supported on or near the bed 148, and thus in bedside relation to the bed occupant. For example, the blower module 10 may be hung or otherwise supported on a headboard or siderail of the bed itself, or on a nightstand, beside table or other piece of nearby furniture, equipment, fixture or wall-mounted support bracket.

A flexible air hose 150 is routed from the outlet duct 34 of the blower module 10 to an air intake port on an exterior of the head tent 146, through which the blown air from the blower module 10 is fed into a substantially enclosed head space bound by the tent around the head of the bed occupant. When the blower module 10 has one or more filters 48, 94 properly installed thereon, the tent-bound headspace is filled and pressurized with filtered air, which prevents unfiltered ambient air (and potential airborne pathogens carried therein) from entering this pressurized headspace, thus supplying the protecting the bed occupant with safely breathable air. The same setup of the mains powered blower module 10, air hose 150 and head tent 146 may be employed without any air filtration means installed on the blower module 10, for example to impart a cooling effect on the head of the bed occupant using non-filtered air. In either of these filtered and unfiltered scenarios, the air cooler module 100 may optionally be installed on the blower module 10, or somewhere in-line therewith but mounted separately therefrom between two segments of flexible air hose 150, to cool the blown air from the blower module 10 at a location upstream from the head tent.

FIG. 12 shows a similar bed application to that of FIG. 11, but in which the relatively small head tent 146 occupying only a head region of the bed to specifically cover the bed occupant's headspace is replaced with a larger body tent 152 that spans a fuller length of the bed, from the head region thereof to at least to a torso region thereof, and in the illustrated example, onward to a foot region of the bed. The body tent 152 thus covers a larger fraction, or entirety, of the bed occupant's body, and the substantially enclosed body space bound by this larger tent 152 is once again filled and pressurized with the blown air from the blower module 10, whether filtered air for airborne pathogen protection, or unfiltered air for body cooling or other purpose. Both the head tent 146 and body tent 152 are of self-supporting design so as not be in any way reliant on the pressurization of the head or body space to prevent collapse of the tent over the bed occupant's face, which would otherwise present a potential suffocation hazard. Self supporting head or body tents usable by bed occupants are commercially available, for example from Hypoxico Altitude Training Systems, for altitude training purposes, and such existing products may be used, or modified for use, for the novel pathogen protection and cooling applications disclosed herein, and so detailed description of similar tent construction is omitted herein in the interest of brevity.

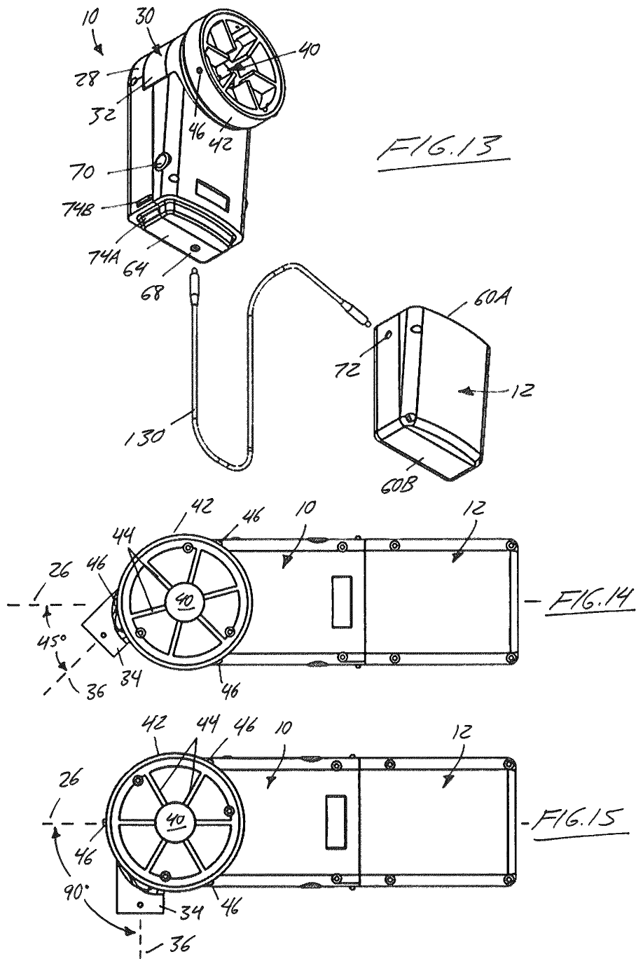

Referring to FIG. 13, one of the same auxiliary electrical connectors 72 on the battery module 12, optionally used to connect the air cooler module 100, can alternatively be used to enable electrical interconnection of the blower and battery modules 10, 12 when mechanically decoupled, for example to enable wearing of the two modules 10, 12 on different areas of a user's body, for example with the battery module worn on a waist belt, and the blower module worn on a shoulder harness or backpack nearer to the user's head. In such instance, one end of the same DC power cord 130 used for the air cooler module 100, or a similar but longer DC power cord, is mated with the auxiliary electrical connector 72 on the battery module 10, and the other end is mated with the same electrical connector 68 on the blower module 10 to which the battery module 12 would be directly connected when mechanically coupled to the blower module 10. In the case that the battery module 12 has a plurality of such auxiliary electrical connectors 72, both the blower module 10 and the air cooler module 100 may both be powered off of the same battery module 12 as one another, despite the battery module's decoupled relation to the separated blower module 10. Likewise, any variety of other DC powered accessories or modules may be powered off the same battery module 12 as the blower module 10 (whether coupled to or decoupled from the blower module).

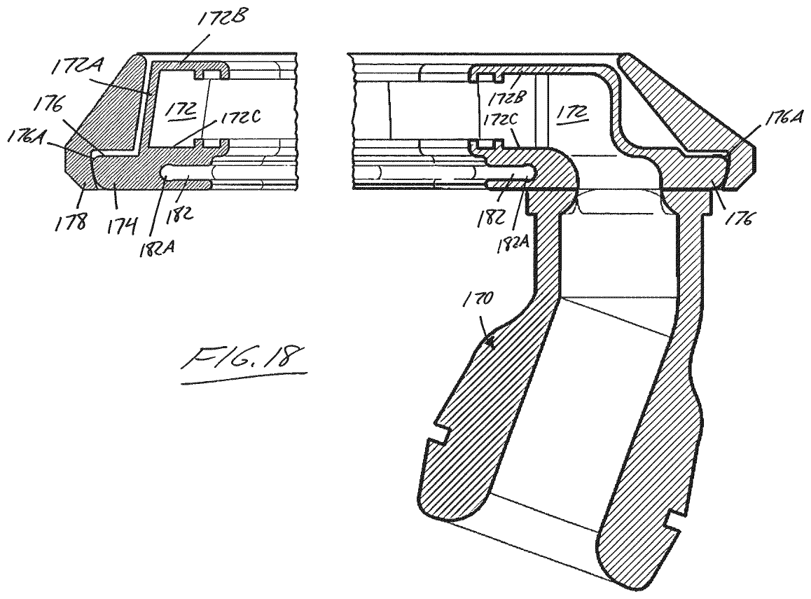

In contrast to the static bed tent applications of FIGS. 11 and 12, most PAPR applications involve wearing of the blower module on the user's body (e.g. via a wearable support such as a waistbelt, shoulder harness, backpack, etc.), together with a worn headgear that fully or substantially encapsulates a facial area or entire head of the user. FIGS. 16 through 18 illustrate a novel headgear assembly of the present invention that is composed of a two-piece rim assembly 160, 162 in combination with a face shield 164 and a piece of flexible sheeting 166. The face shield 164 of the illustrated example is the combined face and head shield disclosed in Applicant's PCT Publication WO2021/195766, the entirety of which is incorporated herein by reference. The shield is composed of a single piece of vacuum formed or thermoformed plastic, creating a shape-stable non-spherical dome with an open rear side through which the wearer's head is received. In practice, the shield is transparent 164, though it is not illustrated as such in the present figures for illustrative convenience.

When the shield 164 is worn, the reference plane containing the open rear side of the shield 10 lies at an oblique incline relative to the anatomical planes of the user's body. This oblique plane cuts through the user's head in a posterior-anterior (back to front) and superior-inferior (top to bottom) direction from a location situated superior to (above) the crown of the user's head, to a location situated inferior to (below) the user's chin and anterior to (in front of) the user's neck. With the open rear side of the shield 10 in this oblique plane, an apex 164A of the shield (denoting an area of its deepest measure from the rear opening) resides anteriorly of the user′ s forehead, from which a depth-tapered lower portion of the shield hangs downwardly over the user's face. The portion of the shield spanning from the forehead-level apex 164A to the bottom end of the shield's rear opening may be referred to as a lower facial portion 164B, since it covers the facial areas of the wearer, while the portion of the shield spanning from the forehead-level apex to the top end of the shield's rear opening may be referred to as the upper cranial portion 164C, since it spans posteriorly over the user's cranium above the scalp. The apex includes a pair of inward depressions 164D disposed symmetrically across a bisecting midplane of the shield's symmetric shape that, per the above incorporated PCT publication, receive a front segment of a headband by which the shield is supported on the user's head. And an airflow channel 164E runs longitudinally of the cranial portion at an interior underside thereof from the top end of the rear opening to the apex 164A, between a pair of recessed troughs that may rest atop the wearer's scalp. The front end of this air channel feeds into an airflow space between the two forehead level depressions 164D, at a central brow ridge of the apex 164A, allowing downflow of air to a face region between the user's face and the lower facial region 164B of the shield 164.

In the worn position of the shield 164, the entire face of the user's head thus resides within the protected interior space of the shield, as does a substantial cranial region of the user's head, including at least the forehead, temples, and frontal scalp, and preferably also including the mid-scalp, and optimally also at least part of the crown of the user's head. The coverage may also include all or parts of the user's ears. So, unlike conventional shields that employ a profiled shape only in the horizontal width direction to curve around to the sides of the face, the dome-like or shell-like shape of the shield 164 also curves upwardly over the forehead and spans rearwardly over the scalp. The shield thus avoids susceptibility to falling droplets or aerosol particles from above, and also protects against accumulation of such contaminants in the user's hair, which can present a risk for later infection.

The rim assembly features a front rim 160 and a rear rim 162 that are of similar ovaloid shape to one another, dictated by a similar ovaloid shape possessed by the perimeter boundary edge 164F of the face shield 164 that bounds the rear opening thereof. The shield 164 includes a small out-turned flange that spans around the entirety of this perimeter edge of the shield's rear opening, and which is most pronounced and visible at locations neighbouring the rear end of the shield's top airflow channel 164E, where the out-turned flange is labelled 164G. The front rim and rear rims 160, 162 are configured for snap-fit engagement with one another in a manner clamping the out-turned perimeter flange of the shield between the two rims 160, 162. One purpose of the rim assembly is to couple the flexible sheeting 166 to the shield 164, thereby converting the face shield 164 into a more hood-like headgear that more comprehensively encloses the entirety of the user's head. The flexible sheeting composed of impermeable material, preferably embodied by a singular flexible sheet of such material, so that the sheeting is a seamless unitary sheet of continuous uninterrupted span in all direction, though in other embodiments the totality of the flexible sheeting may instead be embodied by more than one sheet. In one non-limiting example, the flexible sheeting may be composed of thermoplastic polyurethane (TPU), but of course any other variety of polymeric film, fabric or other sheet-like material of may be used.

The sheeting 166 posses an annular form, having an ovaloid outer perimeter of similar size and shape to the front and rear rims 160, 162, for example for sandwiched receipt of an outer margin of the sheeting therebetween, along with the out-turned flange of the shield. The outer perimeter of the sheeting may be fitted with an elastic 168, in similar fashion to the rim of a shower cap, whereby such elastification of the sheeting's outer perimeter may ease the installation process by imparting a self-tightening of the sheeting's outer margin around the rear rim 162 when placed thereover to best hold the sheeting in place while the face shield 164 and front rim are 160 installed over the sheeting 166 into snap fit relation with the rear rim 162. A head opening or cutout 166A penetrates the sheeting 166 at a distance inward from the elasticized outer perimeter thereof, the purpose of which is to enable admission of the user's head into the headspace that is cooperatively bound between the shield 164 and the sheeting 168 once the headgear is assembled.

Another purpose of the rim assembly 160, 162 is to secure a hose coupler 170 to the face shield. The hose coupler 170 is attached to the rear rim 162, particularly at an upper apex thereof in the illustrated example, thus aligning the hose coupler 170 with a rear inlet end of the air channel 164E in the top of the illustrated shield 164, whereby the hose coupler 170 may be used to feed into this air channel. Accordingly, when an air hose 150 is connected between the hose coupler 170 and the blower module 10 (or the air cooler module 100, if installed), the blower module 10 is operable to blow filtered air into the top air channel 164E of the shield, and onward therethrough to the facial region of the enclosed headspace between the lower facial portion 164B of the shield 164 and the user's face, where such filtered air can thus be inhaled. Meanwhile, the ducting of the breathable filtered air to the facial region via the top air channel 164e of the shield can also impart a head cooling effect to the user for increased comfort, especially in high temperature environments, climates or scenarios. Additionally or alternatively, and as best seen in FIG. 18, a circumferential airflow channel 172 can be provided at an inner perimeter of the rear rim, along which air can be routed from the hose coupling 170 around a rear perimeter area of the enclosed headspace just inside the shield's rear opening, around a full or partial circumference thereof, thus also contributing to delivery of breathable filtered air to the facial region, and/or imparting a cooling effect around the user's head and face.

FIG. 18 is a cross-sectional view of the assembled front and rear rims 160, 162. The rear rim 162 has an out-turned lip 174 that denotes the outermost perimeter of the rear rim around an entirety thereof at a rearmost plane of the rear rim. An outside wall 172A of the circumferential airflow channel 172 protrudes forwardly from the outer lip 174 at a distance inward from the outermost tip thereof, whereby a frontside of the lip denotes a front-facing outside shoulder 176 of the rear rim 162 against which an outer margin of the flexible sheeting 166 and a rear side the out-turned flange of the shield 164 can be received and clamped during snap-fit assembly of the rims. A front wall 172B of the air channel 172 turns inwardly from the outer wall 172A thereof at a frontmost plane of the rear rim 162. The front rim 160, at its rearmost plane, instead of an out-turned lip with a front-facing outside shoulder 176 like the rear rim 162, has a slightly in-turned rear-projecting lip 178 at an outer edge of a rear-facing inside shoulder 180 of the rim 160. This rear lip 178 of the front rim 160 is of reduced radial thickness so as to be capable of slight outward deflection during mating of the two rims, whereafter the deflected lip 178 will return to its natural position. The outside of the rear rim's out-turned lip 174 and the inside the front rim's rear lip 178 are each obliquely angled in an outward direction toward the front of the respective rim, and a front outer corner 176A of the rear rim's out-turned lip 176 is rounded. A snap fit is thus achieved during mating of the two rims, where the rear lip 178 of the front rim 160 will flex outwardly when initially contacted by the rounded front corner 176A of the out-turned lip 174 of the rear rim, and then will snap back to its unflexed position as the rear rim's outside shoulder 176 approaches the front rim's inside shoulder, and eventually abuts a rear side of the shield's out-turned perimeter flange, whose opposing front side abuts the inside shoulder of the front rim. The front and rear sides of the shield's out-turned perimeter flange denote outermost margins of the shield's front and rear sides, whereby the shield is now rimmed around its full perimeter.

Under such snap-fit mating of the two rims 160, 162 together with the out-turned flange of the shield 164 and an outer margin of the flexible sheeting 166 received between the two rims 160, 162, the snapped-together rims thereby secure the flexible sheeting 166 to the shield 164 around the full perimeter thereof. Through the head opening 166A in the flexible sheet 166, the user can insert their head into the now substantially enclosed headspace that is bound between the shield 164 and the flexible sheeting 166, thereby accomplishing a more head-encompassing headgear than the shield 164 alone. The air hose 150 from the PAPR blower module 10 can be connected to this headgear via the rim-carried hose fitting 170 at the top rear of the headgear to deliver filtered air to the now substantially enclosed headspace of the assembled headgear, whether via a top airflow channel 164E of the shield, a circumferential airflow channel 172 of the rear rim, or a combination thereof.

As an alternative to elastic fitting of the flexible sheeting 166 over the rear rim 162 for sandwiched clamping of an outer margin of the flexible sheeting between the two rims 160, 162, the rear rim 162 may include a narrow receiving channel 182 for receiving and holding an outer perimeter of a non-elasticized variant of the flexible sheeting 166. Such a receiving channel 182 can be seen in FIG. 18, where this receiving channel 182 resides in an inward protruding relationship from the out-turned lip 174 at a location behind the optional circumferential airflow channel 172 of the rear rim 162, whose rear wall 172C doubles with a front wall of the smaller receiving channel 180 for the variant flexible sheeting 166. To use this receiving channel 182, a wire or filament (not shown), around which the outer perimeter of the sheeting 166 can be wrapped, is forced into the receiving channel to frictionally retain the sheeting's outer perimeter within the receiving channel. For such purpose, the receiving channel 182 can be seen to have a bulbously rounded outer end 182A of greater diameter sized to accommodate the wire/filament after forcing thereof through a narrower remainder of the channel. That said, the elasticized version of the flexible sheeting is believed easier to install, requiring no more than a simple stretching of the elastic-equipped outer perimeter of the sheeting around the rear rim 162.

While the illustrated example has the hose coupler at the upper rear apex of the rear rim 162, this need not necessary the case, and it could be repositioned, for example closer to a lower front apex thereof so that air introduced via the connected air hose is instead introduced near the chin the of the user, for more direct feeding of breathable air to the facial region of the enclosed headspace. Also, while the two rims 160, 162 of the illustrated example respectively abut front and rear sides of an outer perimeter flange 164G of a flanged shield, similar arrangement of a plurality of matable rim pieces could be clamped together in sandwiching relation to perimeter margins of an unflanged face shield, at the rear/inner side thereof that faces the user's face in the headgear's worn position, and the opposing front/outer side thereof that faces away from the user's face, in order to hold a flexible-sheet around the perimeter of the shield to encompass the user's head between the shield and the flexible sheet. While the shield of the illustrated example is a one-piece face-and-head shield that integrally embodies the facial portion 164B and the cranial portion 164C in a singular unitary construction, the novel rim and sheet assembly may be used on two-piece head and face shield in which the facial and cranial portions are embodied in separate pieces. Such a two-piece head and face shield is disclosed in Applicant's PCT Publication WO2022/115961, the entirety of which is incorporated herein by reference.

It will be appreciated that though the various electrical connectors mentioned above for electrical interconnection of the various components described are illustrated as barrel plugs and barrel sockets, any variety of matable plugs/sockets capable of electric power conduction may be used, including such plugs, sockets and associated cabling that enable signal communication in addition to electric power conduction, for example including universal serial bus (USB) cables and ports of all types, including USB-C. Accordingly, it will be understood that reference made herein to a DC power cable, for example, should be taken to mean any cable capable of conveying DC power, and not to mean a cable dedicated strictly to the conveyance of DC power without any other signal conveying capability. In specifically contemplated embodiments in which the various electric connectors are all embodied by USB-C sockets and plugs, widespread compatibility with a variety of external devices powerable or chargeable by the PAPR is achieved.

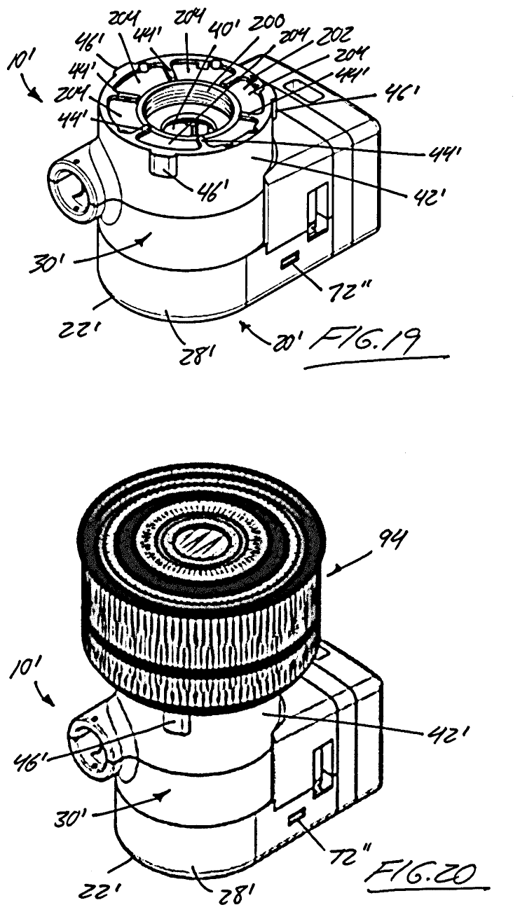

FIGS. 19 and 20 show an alternative embodiment of the blower module 10′, which shares the same general layout of componentry of the earlier embodiment, thus again featuring a main housing 20′ having a lower-profile blower segment 28′ that terminates in an arcuately rounded profile at the blower end 22′ of the module, a generally cylindrical blower housing 30′ rotatably supported atop the blower segment 28′ of the main housing 20′, a taller segment of which protrudes longitudinally from one side of the blower housing and embodies the battery end of the blower module to which the removable battery module (not shown) is selectively couplable. In terms of size and geometry, this embodiment is more compact in the length dimension L of the main housing 20′, but greater in the height dimension H thereof, and comparable or equal in the width dimension W. This embodiment also illustrates that one or more auxiliary electrical connectors 72″ may be embodied on the blower module 10 itself, rather than on the removable battery module, for powering of the air cooler module or other accessories off of the blower module 10, whether the blower module is being run off of a connected battery module, or off of mains power.

That said, a perhaps more notable differentiator of the present embodiment over that described earlier is configuration of the blower inlet embodied at the top end of the blower housing 30. The blower inlet once again features a central inlet opening 40′ that axially and concentrically overlies the blower wheel 33 inside the blower housing 30 on the central blower axis 31. However, rather than being directly neighboured by the relatively tall ribs 44 of the earlier embodiment, the inlet opening 40′ in the present embodiment is instead surrounded by a cylindrical, internally threaded coupling wall 200, whose threading specification corresponds to that of a standardized cannister filter 94 (e.g. 40 mm NATO thread). This way, the threaded neck of such a cannister filter 94 can be engaged with the threaded coupling wall 200 to place the cannister filter 94 in operable relationship to the inlet opening 40′ to filter air admitted therethrough into the blower housing 30 therethrough, as shown in FIG. 20. In alternative to a cannister filter 94, any other variety of filter types (cartridge filters, HEPA filters, etc.) that are either equipped with their own compatible thread, or can be equipped with such thread through attachment of a threaded adapter, may be threadingly coupled to the internally threaded coupling wall 200.

Meanwhile, the blower inlet of this embodiment also retains the ability to accommodate installation of pad filter 48 and associated pad holder 50 of the same general type described above in relation to FIGS. 1 and 2, as an alternative interchangeable filtration option to the cannister filter 94. For such purpose, the outer perimeter wall 42′ of the blower housing 30 is once again provided with a set of studs 46′ thereon for mated coupling with corresponding slots in the pad holder 50. The studs 46′ of are different size and shape in the present embodiment than those shown in earlier figures, but are used for the same purpose and effect of enabling slide-and-turn coupling and securement of a pad holder 50 with compatibly shaped slots in its holding collar 52. The same studs 46′ can also once again be used to instead receive coupling and securement of a dual-filter adapter module 80 of the type described above with reference to FIGS. 3 to 5, whereby the present embodiment of the blower module 10′ can interchangeably use a pad filter 48 (secured in place by a selectively installable pad holder 50), a singular cannister filter 90 directly threaded to the blower housing 30 at the internally threaded coupling wall 200 thereof, or a pair of cannister filters 94 installed indirectly on the blower housing 30 via the dual-filter adapter module 80.

To accommodate placement of a pad filter 48, the blower inlet of the blower module 10′ includes a pad support 202 that surrounds the internally threaded coupling wall 200 at the top end thereof, and radiates outwardly therefrom to the outer perimeter wall 42′ of the blower housing. The pad support 202 includes raised and unraised areas laid out in alternating fashion around the internally threaded coupling wall 200. In the illustrated example, the raised areas of the pad support 202 are embodied by raised ribs 44′ radiating outward from the top end of the coupling wall 200, with topsides of these ribs 44′ residing in a common plane of orthogonal relationship to the central blower axis 31 and of elevated relation to the top end of the coupling wall 200.

The unraised areas between the raised ribs 44′ are coplanar surfaces 204′ of truncated sector shape, residing in a shared plane of orthogonal relationship tot the central blower axis 31, and each being bound between two adjacent ribs 44 in a circumferential direction, and bound between the top end of the coupling wall 200 and the top end of the outer perimeter wall 42′ in the radial direction. These unraised surfaces 204 reside at lesser elevation than the topsides of the raised ribs 44′, for example flush with the top end of the coupling wall 200. When a filter pad 48 is placed atop the pad support 202, a minority surface area of the underside of the pad filter 48 sits atop the raised ribs 44′, while a majority surface area of the underside of the pad filter 48 resides in floating relationship above the central bore of the coupling wall 200 and above the unraised surfaces 204 between the raised ribs 44′ of the pad support 202. During operation of the motorized blower, air can thus be drawn through the pad filter 48 not only at a round center region thereof directly overlying the internal bore of the coupling wall 200, but also at marginal areas of the pad filter suspended over the unraised surfaces 204 between the raised ribs 44′. The height of the raised ribs 44′ in this embodiment is much lesser than the radial ribs 44 of the earlier embodiment, being of notably lesser axial height in this instance than the axial heigh to the coupling wall 200 for example. While the unraised surfaces 204 could be recessed deeper, at elevations below the top end of the coupling wall, such presence of deep pocketing between the pad-supportive ribs 44′ is preferably avoided to ensure easier and thorough cleaning and disinfection of all surfaces of the blower inlet.

Since various modifications can be made in my invention as herein above described, and many apparently widely different embodiments of same made, it is intended that all matter contained in the accompanying specification shall be interpreted as illustrative only and not in a limiting sense.

1. A modular powered air purifying respirator (PAPR) system convertible between differently powered modes of operation, said modular PAPR system comprising:
a blower module having an air inlet through which air is admissible into the blower module and an air outlet through which air is exhaustible from said blower module, said blower module housing one or more electrical components, including at least a motorized blower operable to draw and exhaust air into and from the blower module via said air inlet and said air outlet, respectively;
a removable module configured for selective mechanical and electrical coupling to the blower module in a mated position therewith establishing electrical connection to a control circuit of the motorized blower to enabled powered operation thereof from said removable module; and
an electrical cable connector possessed by the blower module, and also connected to the control circuit of the motorized blower to allow selective powering thereof from mains power via selective connection of a power cable to said cable connector.

2. The modular PAPR system of claim 1 wherein said cable connector of the blower module resides at a location thereon that is obscured by the removable module when coupled to the blower module in said mated position, and revealed upon decoupling of the removable module from the blower module.

3. The modular PAPR system of claim 1 wherein said cable connector of the blower module is a female socket for receiving a male plug of the power cable.

4. The modular PAPR system of claim 1 wherein the removable module has an electrical connector thereon that is of matable relation to the cable connector of the blower module and is matingly engaged therewith in the mated position of the removable module, such that electrical connection of the removable module occurs via the same cable connector to which the power cable is connectable when the removable module is removed from the blower module.

5. The modular PAPR system of claim 1, in combination with a tent erected or erectable over at least part of a bed to at least partially enclose at least a headspace around a head of a bed occupant when lain atop said bed, wherein the system is convertible from a portable battery powered mode in which the blower module is of decoupled relation to mains power and relies on the removable module to power the motorized blower and supply breathable air to a mobile user, and a mains powered mode in which the blower module is connected to a mains power outlet proximate the bed to supply breathable air to the headspace of the bed occupant via mains-powered operation of the motorized blower.

6. The modular PAPR system of claim 5 further comprising a bedside mounting component provided on or attachable to the blower module, and configured for coupling with a stationary support of bedside relation to the bed.

7. The modular PAPR system of claim 6 wherein the bedside mounting component is configured for selective coupling thereof to a bedrail of the bed.

8. An air delivery system for a bed occupant lain atop a bed, said system comprising:
a blower module having an air inlet through which air is admissible into the blower module and an air outlet through which air is exhaustible from said module, said blower module housing one or more electrical components, including at least a motorized blower operable to draw and exhaust air into and from the blower module via said air inlet and said air outlet, respectively;
a tent erected or erectable over at least part of the bed to at least partially enclose at least a headspace around a head of the bed occupant when lain atop said bed;
an air conduit connected or connectable to the air outlet of the blower module and routed or routable therefrom to a working position feeding air from the blower module into the headspace to supply breathable air thereto.

9. The system of claim 8 further comprising a bedside mounting component provided on or attachable to the blower module, and configured for coupling with a stationary support of bedside relation to the bed.

10. The system of claim 9 wherein the bedside mounting component is configured for selective coupling thereof to a bedrail of the bed.

11. The modular PAPR system of claim 1 further comprising a dual filter adapter module configured for selective coupling with the blower module at the air inlet thereof to occupy a working position adjacent thereto, said dual filter adapter module having two adapter module inlets and a singular adapter module outlet, of which the singular adapter module outlet mates with the blower module inlet in the working position of the dual filter adapter module, and the two adapter module inlets are configured to matably receive respective air filters that, with the dual filter adapter and the air filters installed and the motorized blower running, are operable to filter ambient air drawn into the dual filter adapter through said adapter module inlets and onward into the blower module through the mated adapter module outlet and blower module inlet.

12. The modular PAPR system of claim 11, wherein the adapter module comprises a plenum body sized and shaped for mated engagement with the blower module inlet in a position cantilevering to one side thereof, and an inlet tube that lies cross-wise of the plenum body at a cantilevered end thereof and embodies the two adapter module inlets at opposing ends of said inlet tube.

13. The modular PAPR system of claim 11 wherein the adapter module is configured to fit externally over the blower module inlet.

14. The modular PAPR system of claim 13 wherein the blower module inlet comprises a perimeter wall spanning around an inlet opening, and a plurality coupling studs protruding externally from said perimeter wall at discretely spaced positions therearound, and the adapter module outlet is characterized by an internal plenum cavity that fits over the perimeter wall of the blower module inlet and has a plurality of coupling slots in a boundary wall of the plenum cavity at discretely spaced positions therearound for mating engagement with the coupling studs on the perimeter wall of the blower module inlet.

15. The modular PAPR system of claim 11 wherein the blower module inlet and the adapter module outlet are both larger than each of the adapter module inlets.

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. An apparatus for converting a head-borne shield into a more comprehensive head covering for a user's head, said apparatus comprising:
a rim assembly comprising:
a first rim piece for overlying a first peripheral margin area of the head-borne shield at a first side thereof; and
a second rim piece for overlying a second peripheral margin area of the head-borne shield at an opposing second side thereof, said first and second rims being configured for mated coupling to one another to clamp the first and second peripheral margin areas of the head-borne shield therebetween, thereby rendering said head-borne shield a rimmed shield; and
flexible sheeting that, at a peripheral margin thereof, is secured or securable to the rim assembly, and that also delimits a head opening through which the user's head is admissible to a headspace bound between the flexible sheeting and the rimmed shield.

37. The apparatus of claim 36 wherein the rim assembly comprises an air intake at which an air hose is couplable to the rim assembly to convey air into said headspace.

38. The apparatus of claim 36 wherein said first and second rim pieces are front and rear rim pieces for respectively overlying front and rear sides of an out-turned perimeter flange of the head-borne shield.

39. The apparatus of claim 36 wherein the flexible sheeting comprises a singular, seamless sheet.

40. The apparatus of claim 36 wherein the flexible sheeting comprises polymeric sheeting.

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)
